(19) United States
(12) Patent Application Publication
(10) Pub. No.: US 2015/0090725 A1
(43) Pub. Date: Apr. 2, 2015

(54) Cookware with Metal Mesh Embedded in the Base

(71) Applicant: MEYER INTELLECTUAL PROPERTIES LTD., Kowloon, Hong Kong (CN)

(72) Inventor: Stanley Kin Sui Cheng, Hillsborough, CA (US)

(73) Assignee: Meyer Intellectual Properties Ltd., Kowloon (HK)

(21) Appl. No.: 14/385,463

(22) PCT Filed: Mar. 12, 2013
(86) PCT No.: PCT/US2013/030537

§ 371 Date: Sep. 15, 2014

Related U.S. Application Data
(60) Provisional application No. 61/613,337, filed on Mar. 20, 2012.
(60) Provisional application No. 61/705,036, filed on Sep. 24, 2012.

(51) Int. Cl. A47J 27/00; C25D 11/04; C25D 11/18; C25D 11/16

(52) U.S. Cl. CPC A47J 27/002; C25D 11/16; C25D 11/04; C25D 11/18
USPC 220/573.1; 205/206

(57) ABSTRACT

Hard anodized aluminum cookware has either a copper or stainless steel mesh embedded in the base. Copper mesh can be embedded in the bottom or base of the cookware prior to the anodizing process to enhance thermal conductivity and improved cookware's capacity to vertically spread heat. In contrast, stainless steel mesh is embedded in hard anodized aluminum cookware after anodizing, making the cookware suitable for use with the induction ranges or burner's.

### CROSS REFERENCE TO RELATED APPLICATIONS

The present application claims the benefit of priority to the US Provisional Patent Application of the same title that was filed on Mar. 20, 2012, having application Ser. No. 61/613,337, which is incorporated herein by reference.

The present application also claims the benefit of priority to the US Provisional Patent Application of the same title that was filed on Sep. 24, 2012, having application Ser. No. 61/705,036, which is incorporated herein by reference.

The present application also claims the benefit of priority to the International (PCT) patent application that was filed on 12 Mar. 2013, having application serial no. PCT/US13/30537 and is incorporated herein by reference.

### BACKGROUND OF INVENTION

The present invention relates to a cookware article, and in particular to pots and pans that are warned substantially of anodized aluminum.

While many forms of cookware vessels utilize a combination of metals, anodized aluminum cookware is generally formed entirely of aluminum. Additional metals, such as magnetic ferrous materials, enable the use of the anodized cookware with induction heating sources, which rather than providing a hot surface or flame to transfer heat to the vessel, directly heat the vessel by the transfer of energy in the electromagnetic radiation. The electromagnetic radiation is generated by conductive coils in the induction heating source, which upon entering the skin layer of metal induce eddy currents that cause resistive heating in the cookware vessels bottom.

While copper is much more thermally conductive than aluminum, it's incorporation into aluminum requires sophisticated fabrication of the sheet stock used to form the cookware vessel.

Anodized aluminum cookware, although it generally requires a bonded base of magnetic metal for induction cooking, has the benefit of very hard aluminum oxide exterior surfaces formed during anodizing to provide non marring finishes. Although other metals can be used in such cookware to provide induction capability, the aggressiveness of the acidic anodizing solution used to create the aluminum oxide coating usually necessitates additional steps of masking the additional metals layers that would be bonded to the base.

It is therefore a first object of the present invention to provide anodized cookware, which benefit substantially from the harness and durability of the aluminum oxide on the interior and exterior surfaces that incorporates additional metals that provide other benefits.

It is a further objective of the invention to provide such benefits with a minimum additional manufacturing steps and costs.

### SUMMARY OF INVENTION

In the present invention, the first object is achieved by providing an article of cookware, comprising a substantially horizontal bottom, having an interior bottom surface and an exterior bottom surface on the side opposing the interior bottom surface, substantially upright sidewall extending upward from and encircling said bottom to form a fluid retaining interior region, wherein a metal mesh is embedded in the exterior bottom surface, and the vessel other than the metal mesh is formed substantially of aluminum or an alloy of aluminum and has one or more interior and exterior surface portions covered by an aluminum oxide layer.

A second aspect of the invention is characterized in that the metal mesh is copper and is partially exposed on the exterior bottom surface.

Another aspect of the invention is characterized in that the metal mesh is stainless steel and is partially exposed on the exterior bottom surface.

Another aspect of the invention is characterized by providing a process for forming such cookware vessels, the process comprising the steps of providing an aluminum disk, providing a stainless steel mesh, deep drawing the aluminum disk to form a vessel capable of retaining fluid, the vessel having an interior bottom surface and an exterior bottom surface, anodizing the aluminum vessel, providing a compression mold having a male interior member and a female exterior member, wherein the male interior member number substantially conforms to the shape of the interior bottom of the anodized aluminum vessel and has a textured surface, placing the stainless steel mesh and the anodized aluminum vessel 400 in the compression mold with the stainless steel mesh disposed between the female exterior member and the exterior bottom of the anodized aluminum vessel bottom, and compressing the anodized aluminum vessel between the male and female members of the compression mold so as to impart the textured surface of the male member to the interior surface of the anodized aluminum vessel and embed the stainless steel mesh into the exterior bottom portion of the anodized aluminum vessel.

Another aspect of the invention is characterized by providing another process for forming such cookware vessels, the process for forming a cookware vessel, the process comprising the steps of providing an aluminum disk, providing a copper mesh, deep drawing the aluminum disk to form a vessel capable of retaining fluid, the vessel having an interior autumn surface and an exterior bottom surface, providing a compression mold having a male interior member and a female exterior member, wherein the male interior member substantially conforms to the shape of the interior bottom surface of the vessel and the female exterior member substantially conforms to the shape of the exterior bottom surface of the vessel, placing the copper mesh on the aluminum vessel in the compression mold with the copper mesh disposed between the female exterior member and the exterior bottom of the aluminum vessel bottom, compressing the aluminum vessel between the male and female members of the compression mold so as to embed the copper mesh into the exterior bottom of the aluminum vessel, anodizing the aluminum vessel and polishing the bottom of the anodized aluminum vessel to remove oxide formed on the copper mesh.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a perspective view of an inverted cookware article showing the embedding of a metal mesh into the exterior bottom cooking surface.

FIG. 2A through 2F are combination of plan and side elevation views in the steps of forming a metal mesh that can be embedded into the exterior bottom cooking surface of a cookware article.

FIG. 3 illustrates via a cross-sectional elevation a first step in forming the cookware article shown in FIG. 1 from a metal sheet.

FIG. 4 illustrates via a cross-sectional elevation a step in embedding a metal mesh into the bottom exterior surface of the cookware, whereas FIG. 4B is an expanded view of a portion of FIG. 4A.

FIG. 5A is a cross-sectional elevation of the resulting cookware from the embedding step in FIG. 4, whereas FIG. 5B is an expanded view of a portion of FIG. 5A.

FIG. 6 illustrates via a cross-sectional elevation an alternative embodiment of the step of embedding the metal mesh into the bottom exterior surface of the cookware.

FIG. 7A is a cross-sectional elevation of the resulting cookware from the embedding step in FIG. 6, whereas FIG. 7B is an expanded view of a portion of FIG. 7A.

### DETAILED DESCRIPTION

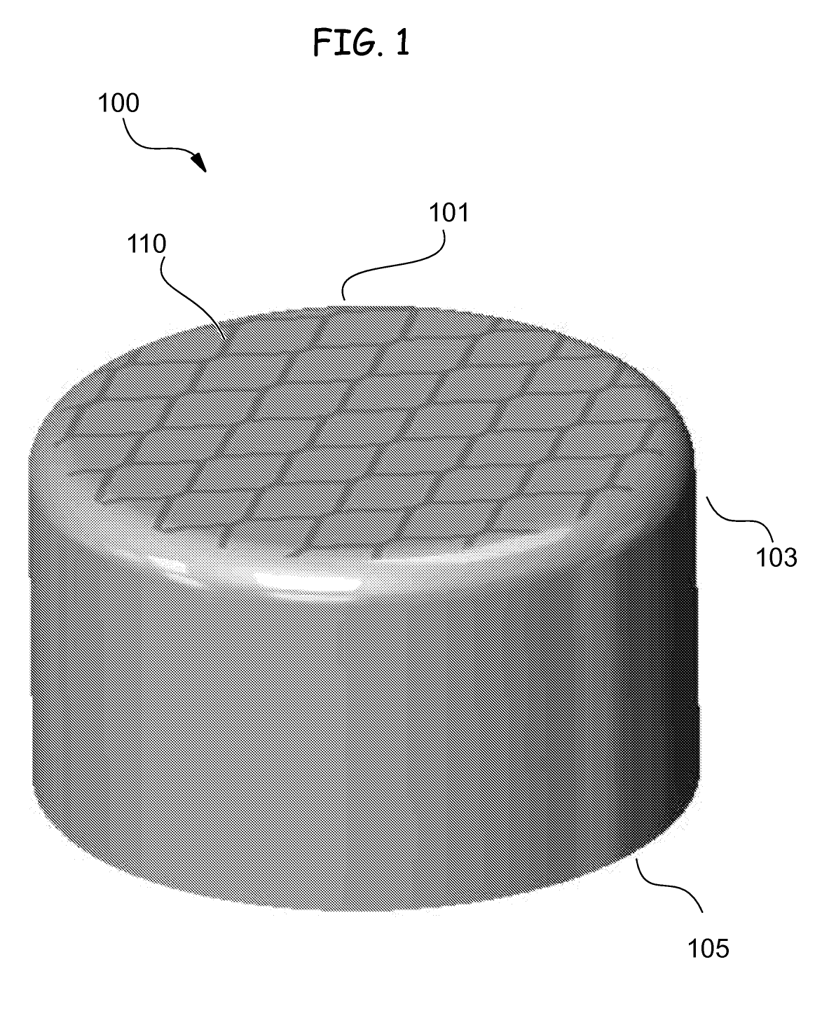

Referring to FIGS. 1 through 7 wherein like reference numerals refer to like components in the various views, there is illustrated therein a new and improved anodized cookware vessel having embedded metal mesh, generally denominated 100 herein.

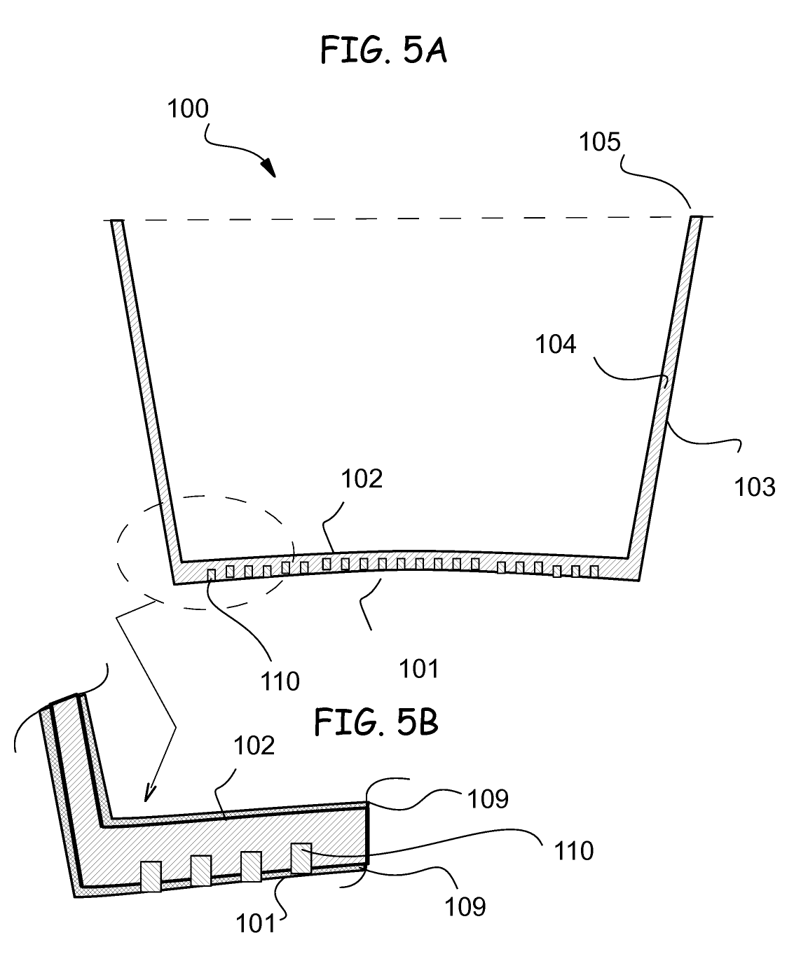

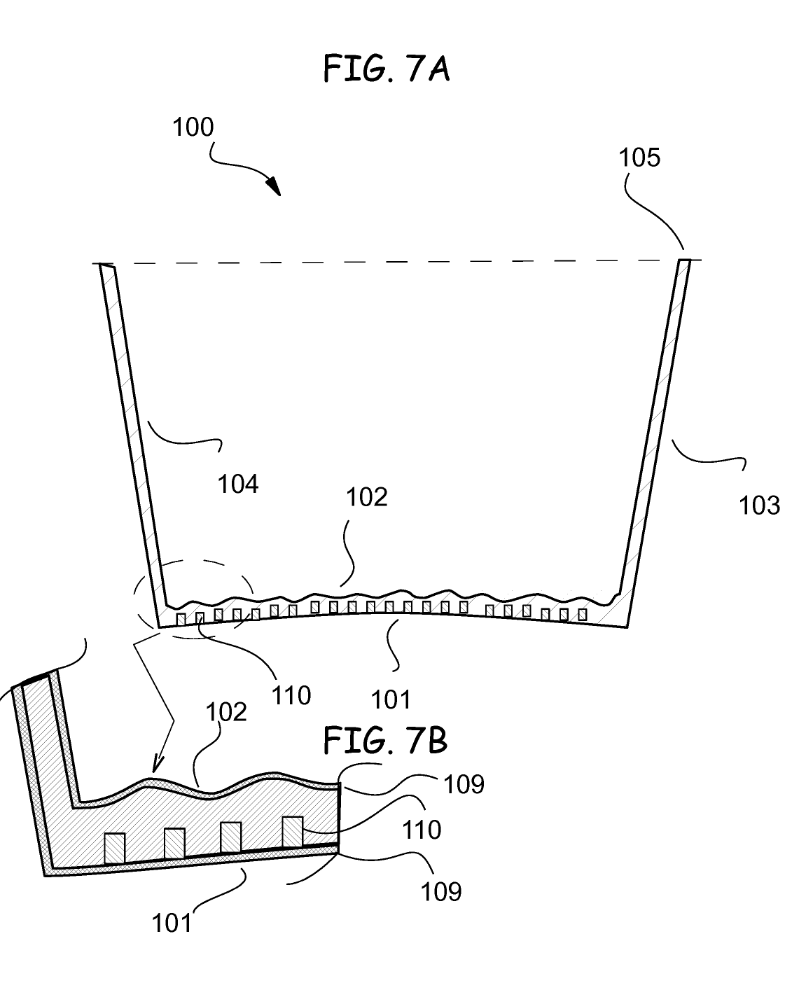

In accordance with the present invention, as illustrated in FIGS. 1, 5 and 7, a cookware article 100 has a bottom portion with the exterior surface 101 facing downward and the opposing bottom interior surface 102 facing upward. Surrounding walls extend substantially upright from the bottom portion to provide a vessel capable of holding a fluid, the walls terminating at a rim 105. The interior surface of the surrounding wall is designated 102 while the exterior surface of the surrounding wall is designated 103. A metal mesh 110 is embedded in the exterior bottom surface 101. The cookware article 100 is formed substantially of aluminum, including alloys of aluminum, and has an anodized exterior surface 109 (see FIGS. 5b and 7B), consisting substantially of aluminum oxide.

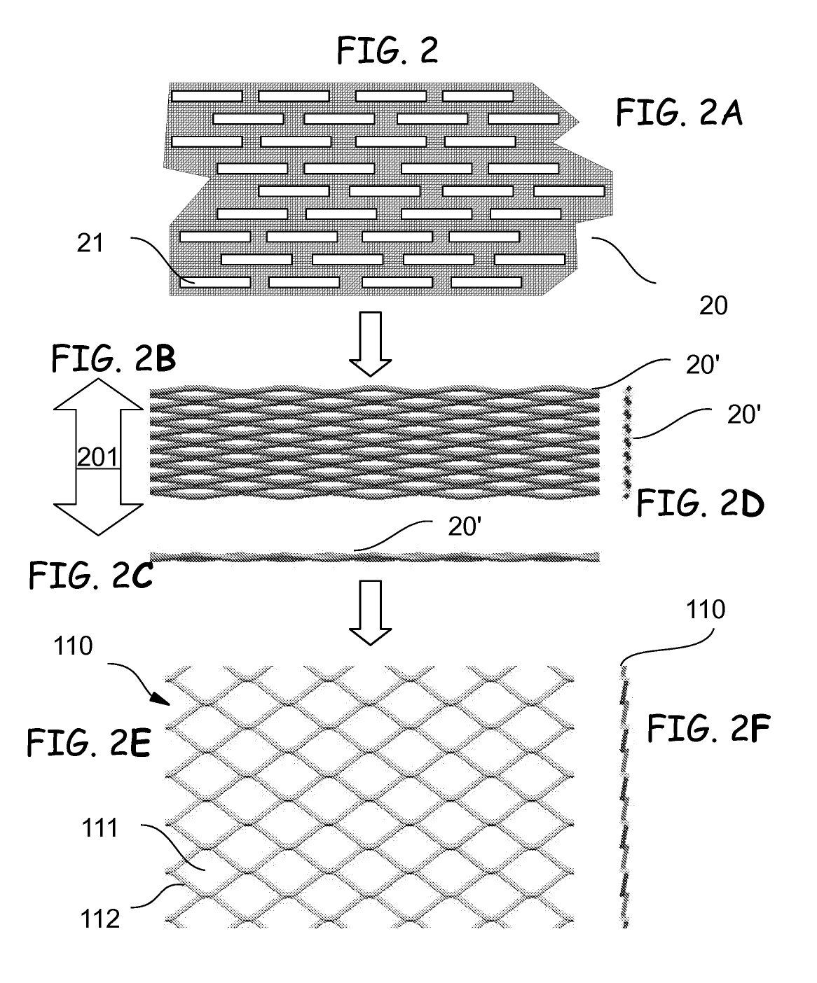

In another embodiment of the invention illustrated in FIGS. 2 A through F, the metal mesh 110 is optionally formed by starting with a planar metal sheet 20. As shown in FIG. 2A, an overlapping array of rows of substantially vertical slits 21 are formed in the metal sheet. In the next step, FIG. 2B, the thus perforated metal mesh 20 is expanded vertically in the direction of arrow 201, which is perpendicular to the slit axis, wherein the slits open up forming rhombohedra with holes 111 shown in plan view in FIGS. 2B & 2E. FIG. 2C-D are orthogonal cross-sectional elevations of the mesh 110 shown in FIG. 2B, whereas FIG. 2F is a cross-sectional elevation of the expanded mesh shown in FIG. 2E in plan view.

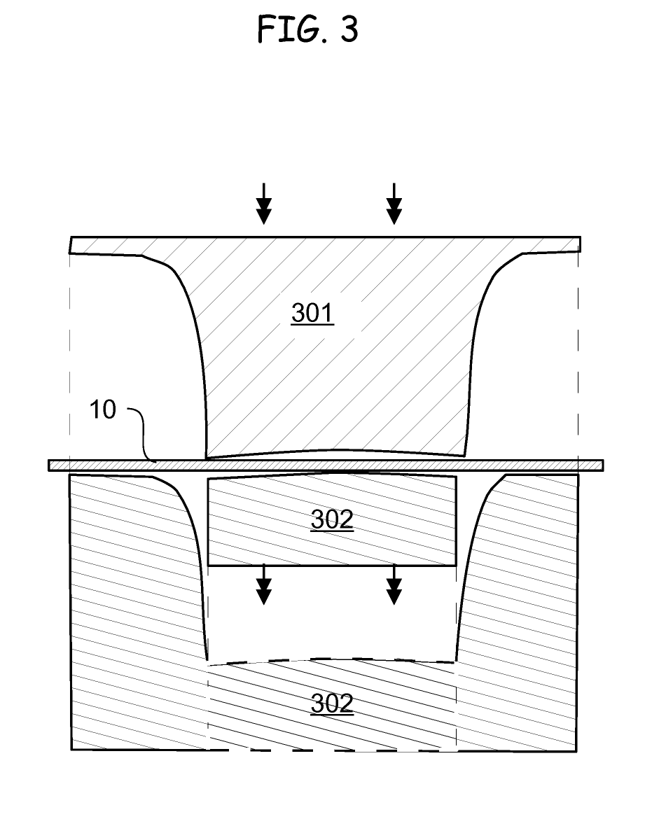

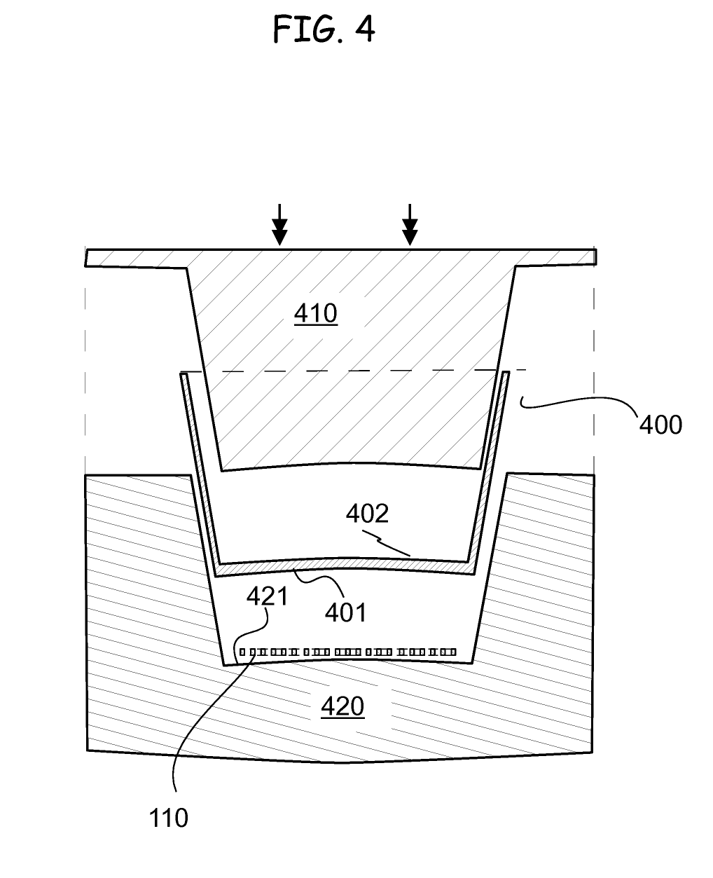

FIGS. 3 through 5 illustrate another embodiment of the invention as a process for forming the cookware article 100 illustrated in FIG. 1 in which the cookware vessel is initially formed in FIG. 3 from a planar sheet of aluminum metal 10 forming pre-form 400, which can then be anodized on substantially all the surfaces, including the exterior bottom 401 and the interior bottom surface 402. Metal sheet 10 is deep drawn between male 310 and female 320 generally mated forming dies, with the perimeter of sheet 10 clamped at arrows 320. The lower forming die 302 has a central portion that moves downward in coordination with the upper male forming die 301. The forming dies 301 and 302 can also provide a slight convex shape to the interior bottom 402 of the vessel pre-form 401, as well as optionally shape the rim 105. As shown in FIG. 4, another pair of mated male 410 and female 420 compression forming dies are then used to force the mesh 110 placed on the upper surface 421 of the lower female forming die 420 into the exterior bottom surface 401 of the pre-form vessel 400 as they assert pressure or compression force of the mesh 110, which then deforms the portion of surface 401 in contact therewith admitting the mesh into the deformed portions, with the pressure from the compression molds 410 and 420 closing the deformed region around the mesh 110 via openings 111. Hence, as shown in FIG. 5, the metal mesh 110 is embedded in the exterior bottom surface 101 of the finished vessel 100. It should be appreciated that the forming dies 410 and 420 can also be used to shape or further shape the bottom surface 401 and 402, as well as the resulting rim region 105 of the finished vessel 100. it was surprising discovered that the vessel pre-form 400 could be anodized before the embedding step shown in FIG. 4, when the mesh 110 was stainless steel, without destroying, delaminating or de-bonding the surfaces thereof that came in contact with the mesh 110 or forming dies 410 and 420. The embedded stainless steel survived multiple shock heating and cooling cycles without de-bonding or distortion of either the stainless steel or the vessel. Typically the vessel pre-form 400 has side and bottom thickness of about 3 mm. To the extent the embedding is done after anodizing, it is preferred that substantially all the shaping of the vessel 100, occurs to the pre-form 400 before anodizing.

FIGS. 3, 6 and 7 illustrate another embodiment of the process for forming the cookware vessel article 100 illustrated in FIG. 1 in which a cookware vessel pre-form 400 vessel is initially formed as shown and described above with respect to FIG. 3 from a planar sheet 10 of aluminum metal or aluminum metal alloy. In this instance, the metal mesh 110 is copper, or an alloy thereof, and is embedded in the bottom exterior surface 101 of the vessel prior to the anodizing step. As shown in FIG. 7, the pair of mated male 410 and female 420 compression forming dies are used to force the mesh 110 placed on the upper surface 421 of the lower female compression forming die 420 into the exterior bottom surface 401 of the pre-form vessel 400. Hence, as shown in FIG. 7, the metal mesh 110 is embedded in the exterior bottom surface 101 of the finished vessel 100. It should be appreciated that the forming dies 410 and 420 can also be used to shape or further shape the bottom surface 401 and 402, as well as the resulting rim region 105 of the finished vessel 100.

It is also preferred that the male metal forming die 410 has a textured lower surface 411 and this textured pattern is imparted to the interior bottom 102 of the cookware vessel 130 during the embedding process. It should be appreciated that the lower or female compression forming die 420 can also be used to shape or further shape the bottom surface 401, and the upper portion of forming dies 410 and 402, to shape or reshape the resulting rim region 105 of the finished vessel 100. The texture thus imparted to surface 102 can be decorative or functional, such as for enhancing the adhesion or durability of inorganic, organic and non-stick coatings, as well as imparting texture or sear marks to food, and can be linear, circular, random, repeating or fractal, as well as a 2-dimensional. This texture can be light or heavy, that is deep between peeks and alleys, and need not cover the entire interior surface. Likewise, the mesh 110, need not cover the entire exterior bottom surface 110, and can be deployed to cover pre-selected portions thereof.

As shown in FIG. 2A-F, the metal mesh 110 is preferably formed by slitting metal sheet 20, shown in FIG. 2A, with rows of overlapping slits 21 and expanding the sheet 20 perpendicular to the slip direction (vertical double arrow 201 in FIG. 2B). It should be noted that in this process, the resulting mesh holes in FIG. 2E, being in the shape of rhombohedra (diamond), which have opposing corners with equal angle, with adjacent corners having angles of about 60 and 30 degree. It should be appreciated that in alternative embodiments of the invention, such mesh 110 can be formed by punching holes in the planar sheet 20, with such holes 111 having any shape, and are optionally square.

Independent of the method of forming the mesh 110, and the shapes of the holes 111 in the mesh 110, it is desirable that the mesh have a particular thickness range and spacing between holes.

Both stainless steel and copper meshes with the thickness of about 0.5 to 1 mm have been successfully embedded in plain aluminum when the mesh openings 111 were from about 3 mm to about 4 mm wide, and the width of the metal between these openings was from about 0.5 mm to about 1 mm, and preferably about 0.75 mm.

To the extent that the mesh 110 is embedded after anodizing process, it is important that the portions of the grid material 112 between the mesh openings 111 are relatively thin and spaced apart and that the mesh material 110 is considerably hard when compared to anodized aluminum.

Stainless steel mesh with a thickness of about 0.5 to 1 mm have been successfully embedded in anodized aluminum when the mesh openings 111 were from about 3 mm to about 4 mm wide, and the width of the metal between these openings was from about 0.5 mm to about 1 mm, and preferably about 0.75 mm. While it has been discovered that it is not possible to embed copper mesh in flat anodized aluminum, stainless steel mesh can be embedded by this process as described above.

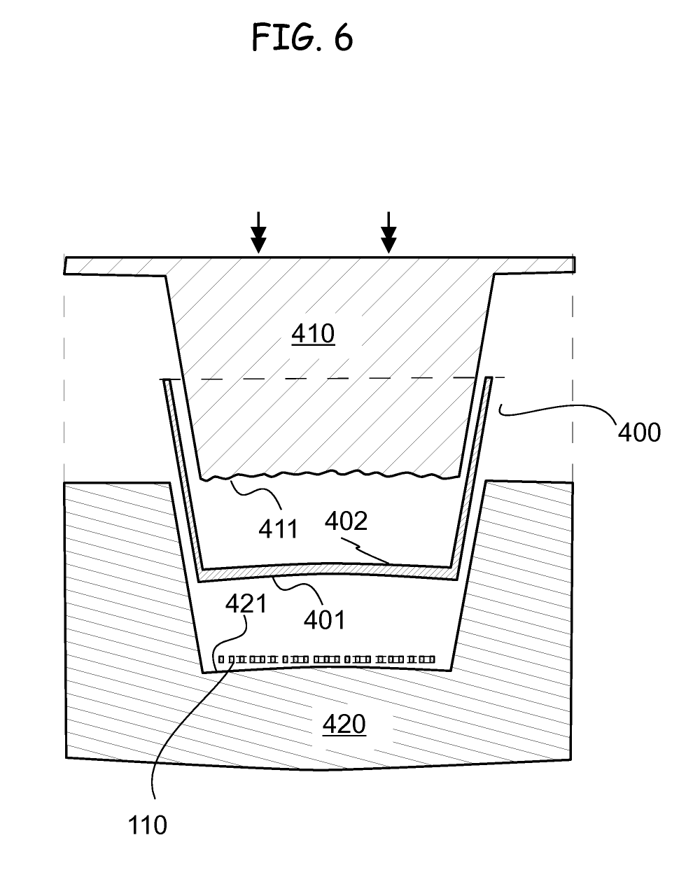

It should also be appreciated that the forming step shown in FIG. 3, or another step prior to the embedding process shown in FIGS. 4 and 6 may be used to place mesh shaped depression in the lower surface 401 of the pre-form 400, hence enabling of a thicker or softer metal into the exterior bottom surface 401 that might be possible with a generally planar surface. This assume registry of the mesh 110 with these depressions. However, the registry in any case may be accomplished even before inserting the pre-form 400 between compression forming dies 410 and 420. This step of forming these depressions can be accomplished by molding, pressing, impacting, machining or electric discharge and like processes. Further, it may be desirable to at least lightly bond the mesh 110 in the depressions, such as by exterior tape, foil or spot welding, as well as inverting the dies 410 and 420 so that the pre-form 400 is inverted and the mesh 110 rests on the surface 401.

Copper mesh 110 can be embedded in the plain aluminum or aluminum alloys exterior base or bottom 101 of the cooking vessel after the drawing to form the basic vessel shape 400. The vessel 400 can then be anodized by conventional methods of applying high current in an acidic bath, thus converting the outer aluminum skin of the surface to a hard and durable aluminum oxide layer. While the exposed portions of the copper mesh will be degraded to at least partially soluble oxides of copper during this anodizing process, the rate of degradation is relatively small compared to the time required to convert the aluminum to aluminum oxide during the anodizing process. Hence, if the copper mesh originally has a thickness of at least about 0.5 mm, and more preferably at least about 1 mm, only a small portion of the copper is oxidizing. The porous or soft copper oxides that remain after the anodizing step are readily removed by a subsequent polishing step. The step of polishing however does not remove a substantial amount of the aluminum oxide from the aluminum vessel.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. An article of cookware, comprising:
a) a substantially horizontal bottom, having an interior bottom surface and an exterior bottom surface on the side opposing the interior bottom surface,
b) a substantially upright sidewall extending upward from and encircling said bottom to form a fluid retaining interior region,
c) a metal mesh embedded in the exterior bottom surface, wherein the wherein the exterior bottom surface consists essentially of an exposed portion of the metal mesh and the portion of the exterior bottom that extends through spaces within the metal mesh, and
d) the vessel other than the metal mesh is formed substantially of one of aluminum and an alloy of aluminum and has one or more of an interior and exterior surface portions covered by an aluminum oxide layer.

2. An article of cookware according to claim 1 wherein the metal mesh is copper.

3. An article of cookware according to claim 1 wherein the metal mesh is stainless steel.

4. An article of cookware according to claim 1 and the metal mesh has thickness of between about 0.5 to about 1 mm.

5. An article of cookware according to claim 1 and the metal mesh has thickness of between about 0.5 to about 1 mm.

6. An article of cookware according to claim 5 and the metal mesh has openings that are from about 3 mm to about 4 mm wide.

7. An article of cookware according to claim 6 wherein the width of the metal between the openings is from about 0.5 mm to about 1 mm.

8. An article of cookware according to claim 5 wherein the width of the metal between the openings is from about 0.5 mm to about 1 mm.

9. A process for forming a cookware vessel, the process comprising the steps of:
a) providing an aluminum disk,
b) providing a stainless steel mesh,
c) deep drawing the aluminum disk to form a vessel capable of retaining a fluid, the vessel having an interior bottom surface and an exterior bottom surface,
d) anodizing the aluminum vessel,
e) providing a compression mold having a male interior member and a female exterior member, wherein the male interior member number substantially conforms to the shape of the interior bottom of the anodized aluminum vessel and has a textured surface,
f) placing the stainless steel mesh and the anodized aluminum vessel in the compression mold with the stainless steel mesh disposed between the female exterior member and the exterior bottom of the anodized aluminum vessel bottom,
g) compressing the anodized aluminum vessel between the male and female members of the compression mold so as to impart the textured surface of the male member to the interior surface of the anodized aluminum vessel and embed the stainless steel mesh 110 into the exterior bottom portion of the anodized aluminum vessel.

10. A process for forming a cookware vessel according to claim 9 wherein the stainless steel mesh has a thickness of between about 0.5 to 1 mm.

11. A process for forming a cookware vessel according to claim 10 wherein the stainless steel mesh has openings are from about 3 mm to about 4 mm wide.

12. A process for forming a cookware vessel according to claim 11 wherein the width of the stainless steel between the openings is between about 0.5 mm to 1 mm.

13. A process for forming a cookware vessel according to claim 9 further comprising a step of forming depression in the exterior bottom aluminum vessel bottom wherein the mesh is placed in the depressions prior to said step of compressing the anodized aluminum vessel between the male and female members of the compression mold.

14. A process for forming a cookware vessel according to claim 13 wherein said step of deep drawing the aluminum disk to form a vessel forms the depressions in the exterior bottom aluminum.

15. A process for forming a cookware vessel, the process comprising the steps of:
a) providing an aluminum disk,
b) providing a copper mesh,
c) deep drawing the aluminum disk to form a vessel capable of retaining fluid, the vessel having an interior autumn surface and an exterior bottom surface,
d) providing a compression mold having a male interior member and a female exterior member 420, wherein the male interior member substantially conforms to the shape of the interior bottom surface of the vessel and the female exterior member substantially conforms to the shape of the exterior bottom surface of the vessel,
e) placing the copper mesh on and the aluminum vessel in the compression mold with the copper mesh disposed between the female exterior member and the exterior bottom of the aluminum vessel bottom,
f) compressing the aluminum vessel between the male and female members of the compression mold so as to embed the copper mesh into the exterior bottom 401 of the aluminum vessel,
g) anodizing the aluminum vessel,
h) polishing the bottom of the anodized aluminum vessel to remove oxide formed on the copper mesh.

16. The process for forming a cookware vessel according to claim 15 wherein said step of anodizing the aluminum vessel forms an oxide of aluminum thereon and the step of polishing does not remove a substantial amount of the aluminum oxide.

17. A process for forming a cookware vessel according to claim 15 further comprising a step of forming depression in the exterior bottom aluminum vessel bottom wherein the mesh is placed in the depressions prior to said step of compressing the anodized aluminum vessel between the male and female members of the compression mold.

18. A process for forming a cookware vessel according to claim 17 wherein said step of deep drawing the aluminum disk to form a vessel forms the depressions in the exterior bottom aluminum.

19. A process for forming a cookware vessel according to claim 18 wherein the copper mesh has a thickness of between about 0.5 to 1 mm.

20. A process for forming a cookware vessel according to claim 19 wherein the width of the copper mesh between the openings is between about 0.5 mm to 1 mm.
